(19) United States
(12) Patent Application Publication
(10) Pub. No.: US 2005/0091539 A1
(43) Pub. Date: Apr. 28, 2005

(54) Supporting auto-logon for multiple devices

(75) Inventors: Zhe Peng Wang, Beijing (CN); Shi Wan Zhao, Beijing (CN); Chang Yan Chi, Beijing (CN)

Correspondence Address: IBM CORPORATION, T.J. WATSON RESEARCH CENTER, P.O. BOX 218, YORKTOWN HEIGHTS, NY, 10598, US

(73) Assignee: International Business Machines Corporation, Armonk, NY (US)

(21) Appl. No.: 10/973,637

(22) Filed: Oct. 26, 2004

(30) Foreign Application Priority Data
Oct. 28, 2003 (CN) 200310104391.3

(51) Int. Cl. G06F 11/30

(52) U.S. Cl. 713/201; 713/155

(57) ABSTRACT

Enables multiple devices of a same user to logon automatically. An example of a method includes: registering the user and the user's multiple user devices with a Multiple Device Authentication (MDA) apparatus; authenticating at least one of the user's registered devices by the MDA apparatus and selecting the authenticated device as a master device; selecting one or more slave devices from the registered user devices; adding the selected master device and one or more selected slave devices to an active device table; if a user device accessing the MDA apparatus is in the active device table, causing the user device logon directly and automatically without first authenticating the user device. Operation of authentication is needed only once to enable user's multiple devices to logon the server automatically and conveniently. Seamless switch between different devices can be implemented, resulting in improved single-sign-on solution over the prior art.

### FIELD OF THE INVENTION

The present invention relates generally to the field of computer networks, and more specifically, to method and apparatus for causing multiple user devices, which are associated with a particular user, to logon automatically.

### BACKGROUND OF THE INVENTION

In the pervasive computing (PvC) era, one user may have multiple devices, such as PDAs (Personal Digital Assistant), cell phones, automotive computers, wearable computers, as well as traditional PCs. Such devices can be connected with each other via means of wired or wireless communications. And also, multiple access channels, such as voice channel, data channel, etc., may be available within one device, e.g., a GPRS (General Packet Radio Service) phone having both data and voice channels available at the same time. The user may access multiple applications and contents provided by various of servers with multiple devices/channels, either in sequential mode, or in simultaneous mode.

Usually, when the user wants to access contents or applications on the servers (the user would send a request via his/her own device and try to access the server which provides applications and contents), the server must verify the identity that the user claims to be. Such a process is called as authentication. When executing one or more applications on a computer, the application is often required to authenticate the user's identity prior to performing any user's actions to prevent unauthorized access to applications. For example, a user may have to provide identity sign with a user name and password, or supply a serial number needed for installing the software, or enter a personal identification number (PIN) (e.g., with Automated Teller Machines (ATMs)). Further more, depending on the client/user's location, different authentication methods may be adopted. For example, if a user logs onto a network at the user's office, he may only need to input the username and password. But if the user wants to log onto his/her office's network from home, he maybe need an additional username and password (or different authentication solutions may be required). Such authentication schemes in the existing technology require that every application (such as the Internet e-mail software, word processing software, ATM software, etc.) to which the user is accessing to be provided with the capability of utilizing various kinds of authentication schemes. For example, each application should provide user with name/password scheme, serial number scheme, user ID/PIN scheme, or other authentication schemes. Thus the application must support new authentication schemes, which makes it necessary to modify the application so as to adapt to various authentication schemes. Therefore, a single-sign-on scheme is presented in the existing technology, which can authenticate the user without modifying each application. For example, there is a single-sign-on scheme disclosed in the U.S. Pat. No. 6,226,752 and it is able to help the user to access different resources across multiple web sites with only one single logon operation.

However, such a single-sign-on scheme has some intrinsic limitations, e.g. it is device-centric, which means that the single logon operation mentioned in the above solution can only be realized when the user limits his/her activities to a client device or channel. But if the user uses multiple devices, or there are multiple channels within one device he used, he must perform the logon operation for each device or channel, i.e., performing multiple or repeated authentication operations. Performing authentication tasks many times is a tiresome and time-consuming work. Especially, in multimodal interaction or sentient computing environments, multiple devices are frequently used to process a continual transaction, and so many authentication processes will break the continuity of the transaction and bring users with isolated, fractional experiences. One of such cases can be imagined that if a user wants to switch to another device when the transaction was self-finished, according to the existing technology, the user must temporarily pause the current transaction and then authenticate another device he wants to switch to. Only after that device passes the authentication, can the previously paused transaction then be continued. However, in multimodal interaction and sentient computing field, it is prevail to use multiple devices. Therefore, it is extremely important that multiple devices belonging to one user have the capability to logon automatically.

In addition, as mentioned above, some devices lack the input ability required by traditional authentication. For example, it is hard for a user to input an alphanumeric password by a phone keypad. One traditional solution for this allows one user to own multiple pairs of user ID and password, each pair being used for a different channel or device. But it is very inconvenient for the user to remember so many IDs and passwords. Therefore, it is necessary to provide the user with one convenient and simple means, which can assist the user devices to pass the authentication easily. Furthermore, when a user uses a public device, it is dangerous for him/her to provide his/her identity sign (e.g. password) if the device's input is being monitored. And when a user utilizes multiple devices in a public environment, the more times the user logs on, the more risks the confidential information exposes, especially for voice channels. The intruder is able to monitor the communication lines and intercept the logon information for his/her own use later. Obviously, there is a need to provide a better method capable of ensuring the security of the user's information all the time.

### SUMMARY OF THE INVENTION

To solve the problems in the existing technology, one aspect of the present invention is to provide methods and apparatus for supporting the auto-logon function for multiple devices so as to simplify the authentication operation for multiple devices of a user in a multimodal interaction or sentient computing environment. According to the present invention, a user-centric, single-sign-on scheme for multiple devices is provided, with which several devices owned by the user can be also authenticated simultaneously by the user's only-one-time logon operation. And then it completes auto-logon operation.

Another aspect of the present invention is to provide a user-centric logon scheme for multiple devices to help the user to log on the system automatically using multiple devices, thus saving the user's effort for multiple or repeated authentication. It also provides the user with seamless and unified experience in the multimodal and sentient computing environment.

Another aspect of the present invention is to provide a secure input method and apparatus for the devices without the capability of input for authentication operation. The method selects a device capable of input required by the authentication operation and secure features, from the devices owned by the user, to log on and then the devices without the capability of input required by authentication operation or the relatively unsecured devices are enabled to log on the system.

Another aspect of the present invention is, when the user utilizes a public device to perform the logon operation, according to the user-centric, not device-centric, logon solution of the present invention, user can log on for only one time with one of the secured. Other devices are then enabled to access all resources, i.e., unsecured devices are authenticated via a secured devices.

According to the present invention, a method for enabling multiple devices of a user to logon automatically is provided. The method comprises steps of: registering the user and the user's multiple user devices with a Multiple Device Authentication (MDA) apparatus; authenticating at least one of the user's registered devices by the MDA apparatus and selecting the authenticated device as a master device; selecting one or more slave devices from the registered user devices; adding the selected master device and the one or more selected slave devices to an active device table; and if a user device accessing the MDA apparatus is in the active device table, causing the user device logon directly and automatically without first authenticating the user device.

According to another aspect of the present invention, a MDA (Multiple Device Authentication) apparatus for enabling a user's multiple devices to logon automatically is provided. Wherein the multiple devices communicate with the MDA apparatus, the multiple user devices logon one or more servers which provide contents or services via the MDA apparatus, and the MDA apparatus comprises: a registration module for receiving registration information of the user and the user's one or more user devices, wherein registered user is associated with the registered user's devices; an authentication module for authenticating at least one of the user's multiple devices, the authenticated device being identified as master device; an active device table storage module for storing the information related to master device and slave devices, wherein the slave devices are referred as one or more user devices selected from the registration module and registered without authentication; and a device access right arbitration module for inquiring if the device accessing the MDA apparatus is in activate device table, and causing the user device to logon automatically when the user device is in activate device table.

### BRIEF DESCRIPTION OF THE DRAWINGS

The invention's features, aspects and the useful effects will be more apparent with the description of the advantageous embodiments and the illustrations in conjunction with the attached drawings, in which:

FIG. 1 is a schematic diagram showing a prior art single-sign-on solution;

FIG. 2 is a schematic diagram showing a multiple device authentication solution according to the present invention;

FIG. 3 illustrates the basic framework and the components of the multiple device authentication solution capable of implementing the present invention;

FIG. 4 illustrates the flow chart of the procedures of the multiple device authentication solution capable of implementing the present invention; and

FIG. 5 illustrates the application of the multiple device authentication solution according to the present invention.

### DETAILED DESCRIPTION OF THE INVENTION

The present invention provides methods, systems and apparatus for supporting the auto-logon function for multiple devices so as to simplify the authentication operation for multiple devices of a user in a multimodal interaction or sentient computing environment. A user-centric, single-sign-on scheme for multiple devices is provided, with which several devices owned by the user can be also authenticated simultaneously by the user's only-one-time logon operation. And then it completes auto-logon operation.

The present invention also provides a user-centric logon scheme for multiple devices to help the user to log on the system automatically using multiple devices, thus saving the user's effort for multiple or repeated authentication. It also provides the user with seamless and unified experience in the multimodal and sentient computing environment.

The present invention further provides a kind of secure input method and apparatus for the devices without the capability of input for authentication operation. The method selects a device capable of input required by the authentication operation and secure features, from the devices owned by the user, to log on and then the devices without the capability of input required by authentication operation or the relatively unsecured devices are enabled to log on the system.

The present invention provides that when the user utilizes a public device to perform the logon operation, according to the user-centric, not device-centric, logon solution of the present invention, user can log on for only one time with one of the secured. Other devices are then enabled to access all resources, i.e., unsecured devices are authenticated via a secured devices.

The scheme of multiple-device authentication according to the present invention provides the user's multiple devices with the capability of auto-logon to the server that provides the services or contents. And at the same time, user can perform the operation of logon by the way that he is used to and switch from one to another among the different devices seamlessly. The solution of multiple-device authentication of the present invention is the natural extension and perfection of the prior art single-sign-on scheme.

The present invention also provides methods for enabling multiple devices of a user to logon automatically is provided. An example of a method comprises the steps of: registering the user and the user's multiple user devices with a Multiple Device Authentication (MDA) apparatus; authenticating at least one of the user's registered devices by the MDA apparatus and selecting the authenticated device as a master device; selecting one or more slave devices from the registered user devices; adding the selected master device and the one or more selected slave devices to an active device table; and if a user device accessing the MDA apparatus is in the active device table, causing the user device logon directly and automatically without first authenticating the user device.

Advantageously, the step of registering the user with the MDA apparatus further comprises registering the user's name, profession, hobbies or customized user information; the step of registering the multiple user devices with the MDA apparatus further comprises registering each of the multiple devices' name, device type and the information of security level; and associating the registered user with one or more registered user devices of the user.

Advantageously, the step of authenticating at least one of the user's registered devices using the MDA apparatus further comprises: the user device sending a request to the MDA apparatus for authentication; the MDA apparatus authenticating the user's device with one or more authentication methods based on the user device's capability information carried in the request, wherein the authentication methods at least includes: user's name/password-based authentication, HTTP-based authentication, form-based authentication, or HTTP client certificate authentication; and the MDA apparatus sending a confirmation message to the authenticated user devices.

Advantageously, the method further comprises steps of: if the master device finds there is an unregistered user device, sending an information related to the unregistered user device to MDA apparatus; the MDA apparatus adding the unregistered user device to a list of user's devices, and then sending the updated list of user's devices to the user; and selecting the unregistered devices and adding the selected unregistered devices to the active device table.

Advantageously, when the user uses another user device to access MDA, the method further comprises steps of: determining whether the another user device is in the active device table; if the result of the determining step is “YES”, then causing the another user device to pass the authentication of the MDA apparatus automatically; and if the result of the determining step is “NO”, then performing the authentication to the other device through the master device.

Advantageously, the step of performing the authentication to the other device through the master device further comprises: the MDA apparatus generating a form containing user's name, password and comment and sending the form to the user; the MDA apparatus querying if the user has authenticated user devices based on the user's name, comment and blanked password, which are input by the user; and then sending the comment to the authenticated user device; confirming another user device on the authenticated user device; and the MDA apparatus performing authentication for another user device automatically according to the confirmation message. Advantageously, the other user device is a public device or a user device with lower security level.

According to another aspect of the present invention, a MDA (Multiple Device Authentication) apparatus for enabling a user's multiple devices to logon automatically is provided. Wherein the multiple devices communicate with the MDA apparatus, the multiple user devices logon one or more servers which provide contents or services via the MDA apparatus, and the MDA apparatus comprises: a registration module for receiving registration information of the user and the user's one or more user devices, wherein registered user is associated with the registered user's devices; an authentication module for authenticating at least one of the user's multiple devices, the authenticated device being identified as master device; an active device table storage module for storing the information related to master device and slave devices, wherein the slave devices are referred as one or more user devices selected from the registration module and registered without authentication; and a device access right arbitration module for inquiring if the device accessing the MDA apparatus is in activate device table, and causing the user device to logon automatically when the user device is in activate device table.

Advantageously, the authentication module uses at least one of the following authentication methods including user's name/password-based authentication, HTTP-based authentication, form-based authentication, HTTP client certificate authentication to authenticate the user devices. Advantageously, the MDA apparatus further comprises: a user's device profile storage module for storing information related to user's multiple devices, wherein the information includes device name, device type and security level; and a user profile storage module for storing information related to the users, wherein the information includes user's name, profession, hobbies and the customized user information. Advantageously, the authentication module is further used to generate a HTTP response which is sent to the user, wherein the response contains the user devices stored in the activate device table and can logon in the name of the user.

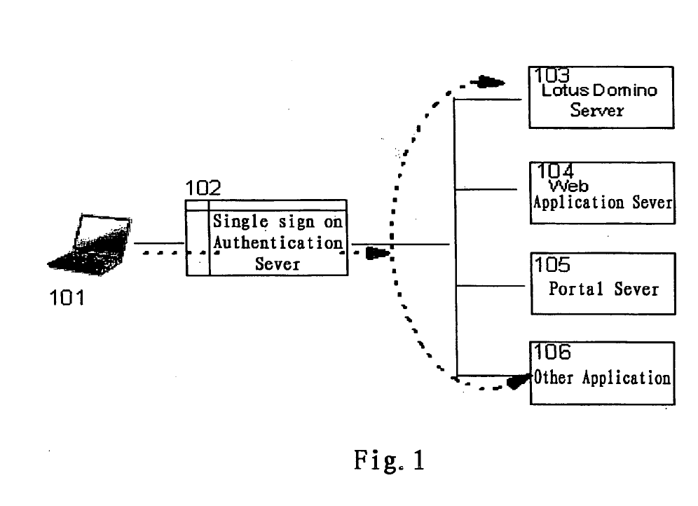

FIG. 1 is a schematic diagram showing a single-sign-on solution. As shown in FIG. 1, with the currently available single-sign-on solutions, if a user wants to access one or more servers, such as a Lotus Domino server 103, a Web application server 104, a portal server 105 or other application server 106, via his/her user devices, the user device 101 should logon the authentication server 102 firstly in order to pass the authentication of server 102. The authentication server 102 is a single-sign-on authentication server, and can involve any authentication solution used in current technologies. The authentication solutions include, but are not limited to, user/password-based authentication, HTTP-based authentication, and form-based authentication or HTTP client certificate-based authentication. The user device 101 to be authenticated in FIG. 1 is shown as a portable computer, but the user device 101 can be other devices, including, but not limited to, a PDA, a cell phone, an automotive computers, a vehicle-carried phone even a wearable computer and other traditional PC. Different user device corresponds to different authentication solution. As it can be seen from FIG. 1, the single-sign-on solution in current technologies has the following limitations:

1. Currently, the available single-sign-on solutions are a device centric single-sign-on scheme in the present technologies, that is to say, though user device can complete the authentication by only-one-time logon operation on one authentication server in order to access multiple servers and the contents therein, if a user has multiple devices, such as a PDA, a cell phone, an automotive phone, even a wearable computer and a traditional PC, the user has to perform the repeated operation of logon to enable every device pass the authentication. It can be imagined that it's a boring and time-consuming thing to perform multiple authentications, especially in a multi-modal interaction, or sentient computing environments in which multiple devices are often used to process a single continual transaction. And so many authentication processes will break the continuity of the transaction and bring user with isolated, high-friction experiences when using multiple devices. One of such cases can be imagined as when a user is performing a transaction and wants to switch to another device, according to the prior art, the user should temperately pause current transaction and then authenticate another device she/he wants to switch to, and as the other device passes the authentication, can the previously paused transaction be continued. It's doomed to be time-consuming and waste a lot of system resources.

2. Some of the user devices lack the capability of input required for traditional authentication. For example, it's difficult for users to input an alphanumeric password by a phone keypad. Under such a circumstance, it's very inconvenient for the user to remember multiple pairs of user ID and password to complete the corresponding authentication.

3. When a user uses a public device, it is dangerous for him/her to provide his/her identity proof (e.g. password) if the device's input is being monitored. And when a user utilizes multiple devices in a public environment, the more times the user logs on, the more risks the confidential information exposes, especially for voice channels.

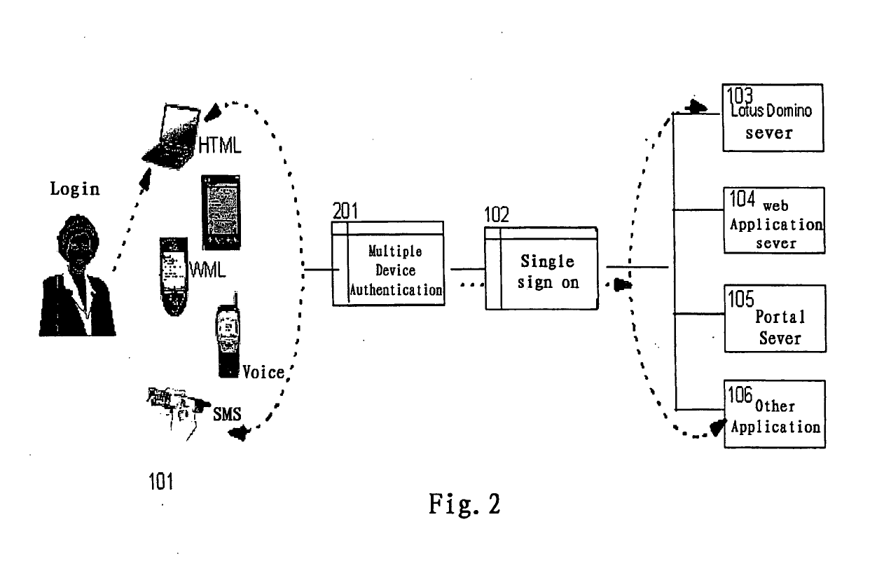

In order to solve the problems in current technologies, it is provided a method and apparatus used in Multiple Device Authentication (MDA) according to the present invention. As shown in FIG. 2, a user-centric system framework of MDA according to the present invention is illustrated. It's same with the FIG. 1, the same reference sign throughout figures represents same part and implements the same functions. There is a difference from FIG. 1 as a MDA apparatus 201 is added between user device 101 and authentication server 102. With the operation of the MDA apparatus 201, user can utilize his/her user devices, the secured device such as laptop, to logon only-one-time, thus can enable other user's devices like PAD, cell phone or other wire or wireless devices to access all the resources. With all kinds of channel, such as HTML (Hyper Text Markup Language), WML (WAP Markup Language), voice channel or data channel, user's multiple devices or one of the user's devices can access the server via MDA apparatus without the necessity of authentication on the server.

The MDA apparatus according to the present invention is composed of a set of components and the software that performs the same function can run it. According to the present invention, the solution of MDA or apparatus can assist the user's multiple devices to logon the system automatically after authentication only once, thus saving the user's effort for multiple authentication and re-authentication (repeated authentication). The present invention enables the user to logon the system with the manner that the user is used to, and to switch between different devices seamlessly.

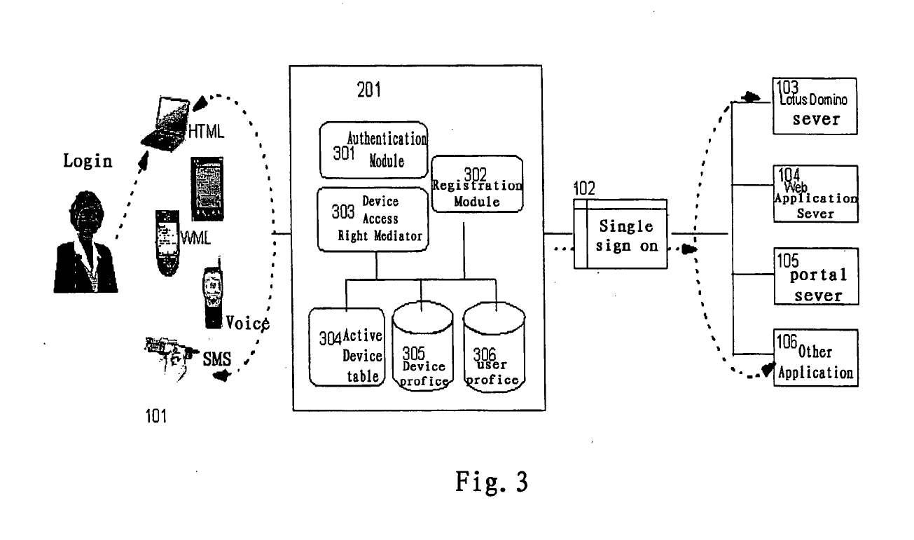

According to the MDA solution of the present invention, the current scheme of single-sign-on is extended, and the multiple-user-device-oriented single-sign-on solution is implemented in the PvC era. Referring to the FIG. 3, detailed description of each component of the MDA apparatus according to the present invention is given as following.

FIG. 3 illustrates the fundamental construct and each corresponding component of the MDA apparatus according to the present invention. The MDA apparatus 201 is provided with at least four components shown below:

1. Authentication Module 301

Authentication module 301 is the basic module of the MDA apparatus. It is used to support multiple authentication solutions, which include, but not be limited to, user name/password-based authentication, HTTP-based authentication, form-based authentication, HTTP client certificate authentication, etc. The authentication module 301 can fetch out a list of devices according to user profile database and generate an HTTP response to the user in order to enable user with the capability of selecting which devices can logon automatically in the name of the user. The selected user device can be stored in an active device table in an active device table storage module 304.

2. Registration Module 302

The MDA apparatus records the information of user and the user's devices with registration module 302. Firstly, user should register the user's personal information and the information of all the devices owned by the user. The MDA apparatus 201 will uniquely identify different user devices with different solutions according to the capability of the user's devices. For example, when user registers a personal computer with the system, the MDA apparatus will generate a unique cookie to identify the user device (PC). For the WAP mobile phone without supporting cookie, the MDA apparatus will use the ID of the user device to identify it. In addition, the MDA apparatus will set different security levels to different user devices.

3. Device Access Right Mediator 303

If user wants to access the system with an unauthenticated device, the authentication module 301 will query the device access right mediator 303 firstly. If the device has been authenticated (the device has been in the active device table), the authentication sign will be took out from the device access right mediator 303 and be send to the background server with the request to notify the server that the device has passed the authentication. At the same time, inform the MDA apparatus that the user device has been authenticated when the response returned. The device access right mediator 303 is in charge of managing the user's devices and the authentication of the devices.

4. Activate/authentication Device Table Storage Module 304

The activate/authentication device table storage module 304 stores the information of user's currently activated devices, including the authenticated user devices (master device) and the devices (slave device) that are selected by the user and can logon automatically in the name of the user. The information includes the ID of the user device, the owner of the user device, the type of the device, the ID of maser user device (the user device that has passed the authentication of MDA), and the expiry time of the user device, etc.

Furthermore, the MDA apparatus is provided with a user devices profile storage module 305 and a user profile storage module 306. They store the information about the capability of the user device and the registration information about the user's identity, which is provided during the process of the user registering with the MDA apparatus. The information about the capability of the user device includes the type of the device, ID, etc. Moreover, the information about user's identity includes, for an example, user's name, profession, hobbies, and such personal information.

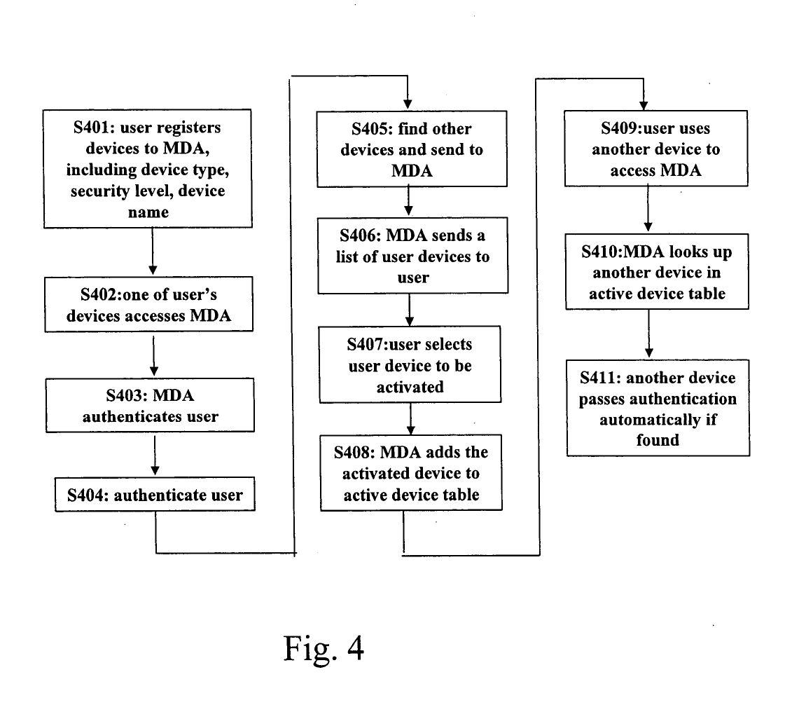

The operation flow of the MDA apparatus is illustrated in FIG. 4.

In the process S401, the user registers all of his/her private user devices and related information with the MDA apparatus. The user devices include, for example, a PDA, a WAP mobile phone, a personal computer, etc. The information related to the devices includes, for example, the type of each user device, security level and the name of the device, etc. Simultaneously, every user's device and the information related to the user device will be stored in the device profile storage module 305. For example, for WAP mobile phone, the MDA knows the capability of the device and can identify the device with its ID. For PC, the MDA apparatus will generate a secure cookie and store it in the PC. During such a procedure, PC can be selected from user's multiple devices as the master device, and connected with the MDA apparatus, then perform the operation of logon the server in order to connect with the network server. In addition, user also registers the user's personal information with the MDA apparatus, and such information is stored in the user profile storage module 306. User's information, which is stored in the user profile storage module 306, includes, for example, user's name, hobbies and other customized information, etc. The user's registration information, which is stored in the user profile storage module 306 is associated with the user's device information stored in the device profile storage module 305.

In the process S402, when user utilizes one of his/her devices to access the application on the server side, the MDA apparatus will require the user to input the user's ID and password, or authentication information. Traditionally, the device is named as master device. In this advantageous embodiment, the user's PC is selected as master device. Moreover, when PC is connected to the MDA apparatus each time, the cookie in the personal computer will be updated for the consideration of security.

In the process S403, the MDA apparatus will authenticate the user's identity. For example, the user inputs user ID and password and submits them to the MDA apparatus. In the process S404, the MDA apparatus adopts the suitable authentication solution to complete the process of authenticating the users. If the authentication result is successful (the user device requesting authentication has been registered with the MDA apparatus in the user profile storage module 306 of the MDA apparatus), the MDA apparatus will look in the user device database, the information stored in the user device profile storage module 305, and find out all the user devices registered before. In addition, in the process S405, if current device (master device) in using has the capability of finding other devices around, it will send the information of the new devices found as well. The MDA apparatus will generate a response and send it to the user based on the capability of the device. The response includes a list of user's devices (the process of S406).

In the process S407, the user can select the device to be used from the received response (the list of user devices). In other words, user can select the user device to be activated. In response to such an operation, in the process S408, the MDA apparatus adds the user device, which is to be activated, to the active device table, and save it in the activate device table storage module 304. Through the process S408, the MDA apparatus will provide the selected user device with the capability of auto-logon. That's to say, the device, which can be found by the master device in the user device profile storage module 305, is a default selection. The selected devices are named as slave devices. Master device and slave devices are in the activate device table. Different devices has different configuration of expiration according to the security level. A slave device will be removed from the active device table if it is inactive for a predetermined time.

In the process S409, if the user utilizes another user device to access to the MDA apparatus, the user will send request to MDA. In the process S410, the MDA will lookup another user device in the active device table. MDA can get the ID of the device, or the confidential cookie from the device's request. Then such information will be used to perform the query in the user's activate device table. If the user device is in the activate device table, it's taken for granted that another user device is the one passed the authentication, and it will be allowed to logon automatically.

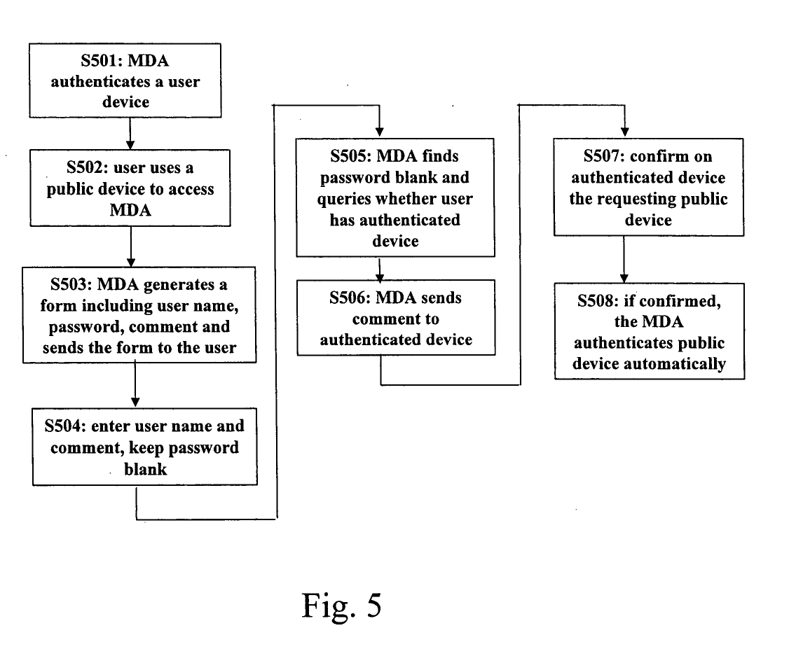

In addition, FIG. 5 illustrates another implementation according to the present invention as well. In such an implementation, with the MDA apparatus, user can user secured device as master device to enable the devices, which are difficult to input user ID and password combined with letters and numbers, or the public devices with unsecured input of user ID and password. Referring to the FIG. 5, the procedures of the practical case are illustrated.

In the process S501, MDA authenticates a user device (master device). It's same with the process S403 and S404 as illustrated in FIG. 4. In the process S502, it is determined if the user utilizes a public device to access to the MDA apparatus. Traditionally, it's possible to expose the password of the user to others when using public or unsecured device to access the contents on the servers. In such circumstance, it can be avoided to expose the user password to others based on the MDA scheme according to the present invention. Referring to the FIG. 5, in the process S503, the MDA responds to the request sent by the users who utilizes the public device, and generates a form, which contains the user name, password, comment, etc. And at the same time, the MDA apparatus will send the form to the user. In the process S504, the user inputs his/her name, comment, and keeps the password field blank. In the process S505, if the MDA apparatus finds that the user does not provide the password, the MDA will inquiry whether the user has owned the authenticated devices. If the user has activated master device (in the activate device table), the request, which contains the information of the comment, will be sent to the user's master device. In the process S507, the user confirms if the public device can make the request on the authenticated user device (master device). In the process S508, if the user finds that the comment was just input by him on the master-device, then the request will be allowed. The MDA will pass the authentication of the public device automatically, and starts to utilize the public device then.

With such operations, a user can utilize a secured device as master device to use public device with unsecured input of user ID and password, thus the danger of exposing the password will be avoided.

While the implementation method of the present invention has been described in connection with attached figures, based on the principle of the present invention, various modifications or improvements of the invention will occur to those skilled in the art without departing from the spirit and scope of the invention as set forth in the attached claims.

The present invention can be realized in hardware, software, or a combination of hardware and software. The present invention can be realized in a centralized fashion in one computer system, or in a distributed fashion where different elements are spread across several interconnected computer systems. Any kind of computer system—or other apparatus adapted for carrying out the methods described herein—is suitable. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which—when loaded in a computer system—is able to carry out these methods.

Computer program means or computer program in the present context mean any expression, in any language, code or notation, of a set of instructions intended to cause a system having an information processing capability to perform a particular function either directly or after conversion to another language, code or notation and/or reproduction in a different material form.

It is noted that the foregoing has outlined some of the more pertinent objects and embodiments of the present invention. This invention may be used for many applications. Thus, although the description is made for particular arrangements and methods, the intent and concept of the invention is suitable and applicable to other arrangements' and applications. It will be clear to those skilled in the art that other modifications to the disclosed embodiments can be effected without departing from the spirit and scope of the invention. The described embodiments ought to be construed to be merely illustrative of some of the more prominent features and applications of the invention. Other beneficial results can be realized by applying the disclosed invention in a different manner or modifying the invention in ways known to those familiar with the art.

1. A method for enabling multiple user devices of a user to logon automatically, comprising steps of:
registering said user and said user's multiple user devices with a Multiple Device Authentication (MDA) apparatus;
authenticating at least one of the user's registered devices by said MDA apparatus and selecting said authenticated device as a master device;
selecting at least one slave devices from said registered user devices;
Adding said selected master device and the at least one selected slave devices to an active device table; and
if a user device accessing said MDA apparatus is in said active device table, causing said user device logon directly and automatically without first authenticating said user device.

2. The method according to claim 1, characterized in that:
the step of registering said user with the MDA apparatus further comprises registering said user's name, profession, hobbies or customized user information;
the step of registering said multiple user devices with the MDA apparatus further comprises registering each of said multiple devices' name, device type and the information of security level; and
associating said registered user with at least one registered user devices of said user.

3. The method according to claim 1, characterized in that the step of authenticating at least one of the user's registered devices using said MDA apparatus further comprises:
said user device sending a request to the MDA apparatus for authentication;
said MDA apparatus authenticating the user's device with at least one authentication methods based on the user device's capability information carried in said request, wherein said authentication methods at least includes: user's name/password-based authentication, HTTP-based authentication, form-based authentication, or HTTP client certificate authentication; and
said MDA apparatus sending a confirmation message to said authenticated user devices.

4. The method according to claim 1 further comprising steps of:
if said master device finds there is an unregistered user device, sending an information related to the unregistered user device to MDA apparatus;
said MDA apparatus adding said unregistered user device to a list of user's devices, and then sending the updated list of user's devices to said user; and
selecting said unregistered devices and adding the selected unregistered devices to the active device table.

5. The method according to claim 1, characterized in that when the user uses another user device to access MDA, said method further comprises steps of:
determining whether said another user device is in the active device table;
if the result of said determining step is “YES”, then causing said another user device to pass the authentication of the MDA apparatus automatically; and
if the result of said determining step is “NO”, then performing the authentication to said other device through said master device.

6. The method according to claim 1 or claim 5, characterized in that the step of performing the authentication to said other device through said master device further comprises:
said MDA apparatus generating a form containing user's name, password and comment and sending said form to the user;
said MDA apparatus querying if said user has authenticated user devices based on the user's name, comment and blanked password, which are input by said user; and then sending the comment to said authenticated user device;
confirming another user device on the authenticated user device; and
said MDA apparatus performing authentication for another user device automatically according to the confirmation message.

7. The method according to claim 6, characterized in that said another user device is a public device or a user device with lower security level.

8. A MDA (Multiple Device Authentication) apparatus for enabling a user's multiple devices to logon automatically, wherein said multiple devices communicate with said MDA apparatus, the multiple user devices logon at least one servers which provide contents or services via said MDA apparatus, characterized in that said MDA apparatus comprises:
a registration module for receiving registration information of the user and the user's at least one user devices, wherein registered user is associated with the registered user's devices;
an authentication module for authenticating at least one of the user's multiple devices, said authenticated device being identified as master device;
an active devices table storage module for storing the information related to master device and slave devices, wherein the slave devices are referred as at least one user devices selected from the registration module and registered without authentication; and
a device access right arbitration module for inquiring if the device accessing said MDA apparatus is in activate device table, and causing said user device to logon automatically when said user device is in activate device table.

9. The apparatus according to claim 8, wherein said authentication module uses at least one of the following authentication methods including user's name/password-based authentication, HTTP-based authentication, form-based authentication, HTTP client certificate authentication to authenticate said user devices.

10. The apparatus according to claim 8 further comprising:
a user's device profile storage module for storing information related to user's multiple devices, wherein said information includes device name, device type and security level; and
a user profile storage module for storing information related to the users, wherein said information includes user's name, profession, hobbies and customized user information.

11. The apparatus according to claim 8, characterized in that said authentication module is further used to generate a HTTP response which is sent to said user, wherein said response contains the user devices stored in said activate device table and can logon in the name of said user.

12. A program storage device readable by machine, tangibly embodying a program of instructions executable by the machine to perform method steps for enabling multiple user devices of a user to logon automatically, said method steps comprising the steps of claim 1.

13. An article of manufacture comprising a computer usable medium having computer readable program code means embodied therein for causing enablement of multiple user devices of a user to logon automatically, the computer readable program code means in said article of manufacture comprising computer readable program code means for causing a computer to effect the steps of:
registering said user and said user's multiple user devices with a Multiple Device Authentication (MDA) apparatus;
authenticating at least one of the user's registered devices by said MDA apparatus and selecting said authenticated device as a master device;
selecting at least one slave devices from said registered user devices;
Adding said selected master device and the at least one selected slave devices to an active device table; and
if a user device accessing said MDA apparatus is in said active device table, causing said user device logon directly and automatically without first authenticating said user device.

14. A computer program product comprising a computer usable medium having computer readable program code means embodied therein for causing functions of an MDA (Multiple Device Authentication) apparatus for enabling a user's multiple devices to logon automatically, wherein said multiple devices communicate with said MDA apparatus, the multiple user devices logon at least one servers which provide contents or services via said MDA apparatus, the computer readable program code means in said computer program product comprising computer readable program code means for causing a computer to effect:
a registration module for receiving registration information of the user and the user's at least one user devices, wherein registered user is associated with the registered user's devices;
an authentication module for authenticating at least one of the user's multiple devices, said authenticated device being identified as master device;
an active devices table storage module for storing the information related to master device and slave devices, wherein the slave devices are referred as at least one user devices selected from the registration module and registered without authentication; and
a device access right arbitration module for inquiring if the device accessing said MDA apparatus is in activate device table, and causing said user device to logon automatically when said user device is in activate device table.

15. A computer program product as recited in claim 14, wherein said authentication module uses at least one of the following authentication methods including user's name/password-based authentication, HTTP-based authentication, form-based authentication, HTTP client certificate authentication to authenticate said user devices.

16. A computer program product as recited in claim B 1, the computer readable program code means in said computer program product further comprising computer readable program code means for causing a computer to effect a user's device profile storage module for storing information related to user's multiple devices, wherein said information includes device name, device type and security level; and
a user profile storage module for storing information related to the users, wherein said information includes user's name, profession, hobbies and customized user information.

17. A computer program product as recited in claim B1, wherein said authentication module is further used to generate a HTTP response which is sent to said user, wherein said response contains the user devices stored in said activate device table and can logon in the name of said user.

18. An article of manufacture as recited in claim 13, the computer readable program code means in said article of manufacture wherein:
the step of registering said user with the MDA apparatus further comprises registering said user's name, profession, hobbies or customized user information;
the step of registering said multiple user devices with the MDA apparatus further comprises registering each of said multiple devices' name, device type and the information of security level; and
further comprising computer readable program code means for causing a computer to effect associating said registered user with at least one registered user devices of said user.

19. An article of manufacture as recited in claim Al, the computer readable program code means in said article of manufacture wherein:
the step of authenticating at least one of the user's registered devices using said MDA apparatus further comprises:
said user device sending a request to the MDA apparatus for authentication;
said MDA apparatus authenticating the user's device with at least one authentication methods based on the user device's capability information carried in said request, wherein said authentication methods at least includes: user's name/password-based authentication, HTTP-based authentication, form-based authentication, or HTTP client certificate authentication; and
said MDA apparatus sending a confirmation message to said authenticated user devices.

20. An article of manufacture as recited in claim A1, the computer readable program code means in said article of manufacture further comprising computer readable program code means for causing a computer to effect steps of:
if said master device finds there is an unregistered user device, sending an information related to the unregistered user device to MDA apparatus;
said MDA apparatus adding said unregistered user device to a list of user's devices, and then sending the updated list of user's devices to said user; and
selecting said unregistered devices and adding the selected unregistered devices to the active device table.
